(19) United States
(12) Patent Application Publication
(10) Pub. No.: US 2017/0160997 A1
(43) Pub. Date: Jun. 8, 2017

(54) INFORMATION PROCESSING APPARATUS THAT DETERMINES CONFLICT RESULTING FROM CONTENTS OF PRINT SETTING ITEMS, CONTROL METHOD FOR INFORMATION PROCESSING APPARATUS, AND STORAGE MEDIUM

(71) Applicant: CANON KABUSHIKI KAISHA, Tokyo (JP)

(72) Inventors: Naoki Morita, Kashiwa-shi (JP); Hiroshi Oya, Nagareyama-shi (JP); Takashi Okazawa, Tokyo (JP); Toru Sakaguchi, Kashiwa-shi (JP); Chie Ito, Abiko-shi (JP)

(21) Appl. No.: 15/363,462

(22) Filed: Nov. 29, 2016

(30) Foreign Application Priority Data
Dec. 4, 2015 (JP) 2015-237396

(51) Int. Cl. G06F 3/12; G06K 15/02; H04N 1/00

(52) U.S. Cl. CPC G06F 3/1255; H04N 1/00114; G06F 3/1205; G06F 3/121; G06F 3/1225; G06F 3/1248; G06K 15/1813; G06K 15/1822

(57) ABSTRACT

A control method for an information processing apparatus which prevent a page of a print job including a print setting which cannot be addressed by an image forming apparatus from being transmitted to the image forming apparatus. A print job generated in a printer driver to cause an image forming apparatus to perform printing is received from the printer driver. A print setting included in the received print job is analyzed based on conflict information for managing a combination that includes a combination of contents of print setting items that causes a conflict and is unmanageable by the printer driver. When the print job is transmitted, at least a page that causes a conflict with respect to the image forming apparatus, in the print job, is not transmitted based on a result of the analysis.

### BACKGROUND OF THE INVENTION

Field of the Invention

The present invention relates to an information processing apparatus that determines a conflict resulting from contents of print setting items to cause an image forming apparatus to print a print job, a control method for the information processing apparatus, and a storage medium.

Description of the Related Art

In order to use a peripheral apparatus such as an image forming apparatus from an information processing apparatus, it is necessary in general to integrate a particular device driver complying with the peripheral apparatus (in case of an image forming apparatus, a printer driver) into an operating system (OS) running on the information processing apparatus. When using the image forming apparatus, a printer driver is activated from an application, necessary settings are performed for printing, image data and a print setting (hereinafter collectively referred to as a print job) are generated, and the generated print job is transmitted to the image forming apparatus. The image forming apparatus which has received the print job performs an image generation process (hereinafter referred to as rendering) in accordance with the print setting, and performs a print process to sheet.

Conventional printer drivers include, as a main component, a user interface module, a print job generation module, and a control module. The user interface module manages input from a user and an application. The print job generation module generates a print job. Conventional printer drivers further include, as a main component, a communication control module (hereinafter referred to as a language monitor) which controls a communication process between image forming apparatuses. A printer driver constituted by a group of these modules is called, for example, a Version 3 driver (hereinafter described as a V3 driver) of Windows (registered trademark). The language monitor receives a print job generated by the print job generation module through an OS, and transmits the print job to an image forming apparatus. When receiving a request for canceling the print job or the like from a user or an application, the language monitor performs a process in accordance with the request to control the job.

In addition, there is a V3 driver which includes an extended language monitor. The extended language monitor not only transmits a print job from a printer driver but also receives device information from an image forming apparatus and supports a protocol for print communication to be used. With the language monitor which supports the protocol, it is possible to execute stable printing even in an image forming apparatus with a small amount of memory by the printer driver constantly confirming a state of memory in the image forming apparatus as information. In addition, with the language monitor, the information processing apparatus can collect detailed states of the image forming apparatus, and thereby the language monitor can perform management and control of the print job, which are originally performed in the image forming apparatus.

There is a widely commercialized system in which a collected state of an image forming apparatus or a message to a user is displayed, and input of settings to the image forming apparatus and the like can be performed by an application in an information processing apparatus. In such a system, a panel display device in the image forming apparatus can be simplified. Furthermore, there is a commercialized system in which printing is performed by transmitting, to an image forming apparatus, image data obtained by rendering by a V3 driver in an information processing apparatus, without performing rendering in the image forming apparatus.

On the other hand, a new printer driver, which includes a configuration different from that described above, has been recently adopted in Windows 8 (registered trademark) introduced by Microsoft Corporation. A group of modules which constitutes the new printer driver does not include a language monitor. In addition, available communication ports are limited to a universal serial bus (USB) port and a web service on device (WSD) port. A printer driver having the configuration is called a Version 4 driver (hereinafter described as a V4 driver). Since V4 drivers do not include a language monitor, a function to perform a transmission process of a print job generated by a print job generation module to an image forming apparatus is provided by a spooler mounted on Windows as a standard component.

V3 drivers have a function to address a conflict. With the function, V3 drivers confirm whether there occurs a combination of print setting items of a print job which cannot be set simultaneously (conflict), and eliminate, if any, the combination of which print setting items cannot be set simultaneously. Accordingly, a conflict has been addressed by V3 driver in information processing apparatuses. For example, when settings include double-sided printing as an output setting and a sheet size which cannot be used for double-sided printing, these print settings are not consistent with each other and regarded as a conflict. As a result, the conflict has been addressed in such a way that the output method is changed to one-sided printing.

As conventional art, a method has been proposed in which in order to perform printing with a print setting suitable for an image forming apparatus, a print job is temporarily accumulated in a server, and printing is performed after receiving a print request and a print setting change instruction, and changing the print setting in accordance therewith (Japanese Laid-Open Patent Publication (kokai) No. 2012-94113).

However, in V4 drivers, print setting items, for which V4 drivers can confirm whether a conflict is caused, are limited by the OS. Consequently, V4 drivers cannot manage many combinations of print setting items unlike the V3 drivers. In other words, V4 drivers can address only a part of conflicts addressed by conventional V3 drivers, and regarding combinations of print setting items which cannot be managed by V4 drivers, it is not determined whether a conflict is caused thereby. Therefore, there is a risk that a print job including inconsistent print settings which cannot be addressed by an image forming apparatus is input to the image forming apparatus, which is a problem.

### SUMMARY OF THE INVENTION

The present invention provides an information processing apparatus and a control method therefor, which prevent a page of a print job including a print setting which cannot be addressed by an image forming apparatus from being transmitted to the image forming apparatus, and a storage medium.

Accordingly, the present invention provides a control method for an information processing apparatus, comprising a reception step of receiving a print job generated in a printer driver to cause an image forming apparatus to perform printing, from the printer driver, an analysis step of analyzing a print setting included in the print job received in the reception step based on conflict information for managing a combination that includes a combination of contents of print setting items that causes a conflict and is unmanageable by the printer driver, and a transmission step of transmitting the print job to the image forming apparatus, wherein in the transmission step, when the print job is transmitted, at least a page that causes a conflict with respect to the image forming apparatus, in the print job, is not transmitted based on a result of the analysis performed in said analysis step.

According to the present invention, it is possible to prevent a page of a print job including a print setting which cannot be addressed by an image forming apparatus from being transmitted to the image forming apparatus.

Further features of the present invention will become apparent from the following description of exemplary embodiments (with reference to the attached drawings).

### BRIEF DESCRIPTION OF THE DRAWINGS

FIG. 1 is a diagram showing an overall configuration of a print system.

FIG. 2 is a diagram showing a software configuration of a V4 driver.

FIG. 3 is a diagram showing a software configuration of a virtual device service.

FIG. 4 is a block diagram showing a hardware configuration of an image forming apparatus.

FIG. 5 is a view showing an example of a UI displayed by a UI control unit.

FIG. 6 is a flowchart of a conflict-addressing process performed by a print setting management unit.

FIG. 7 is a view showing an example of a warning message displayed in a print setting dialog.

FIG. 8 is a flowchart of a conflict-addressing process performed by a virtual device language monitor.

FIG. 9 is a view showing an example of an error screen displayed in a status window.

FIG. 10 is a diagram showing an example of conflict information which can be incorporated in a V4 driver.

FIG. 11 is a diagram showing an example of conflict information incorporated in the virtual device service.

### DESCRIPTION OF THE EMBODIMENTS

Hereinbelow, an embodiment of the present invention will be described with reference to the drawings.

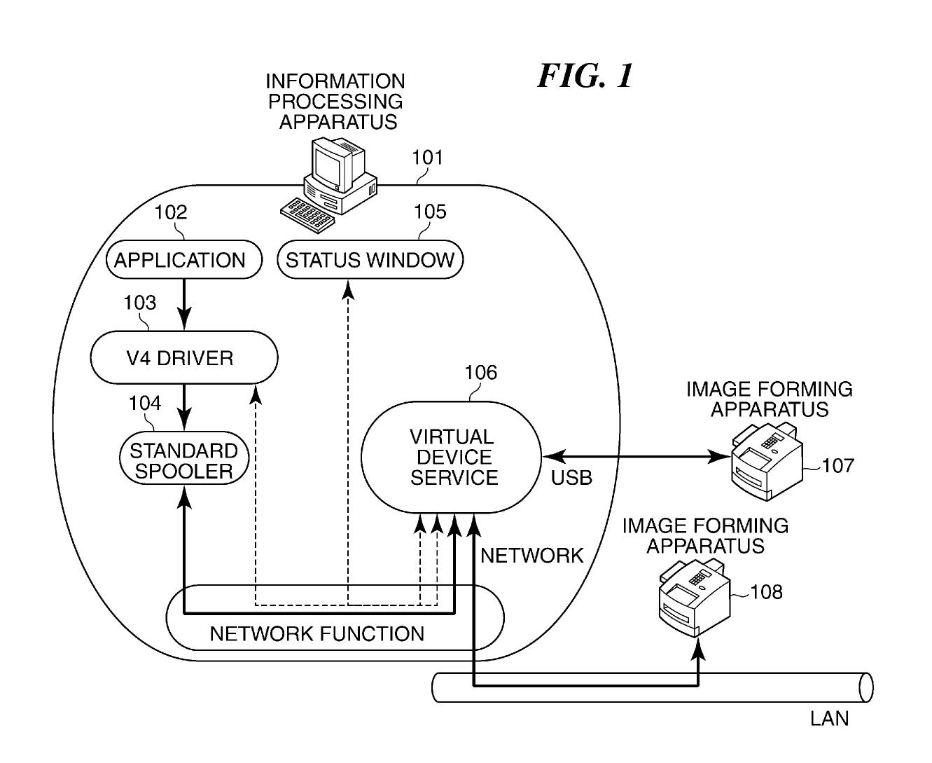

FIG. 1 is a diagram showing an overall configuration of a print system including an information processing apparatus according to an embodiment of the present invention. Arrows of thick solid line in the drawing show communication relating to print jobs, and arrows of fine dotted line show communication relating to data other than print jobs. Image forming apparatuses 107 and 108 which form an image based on a print job are connected to an information processing apparatus 101. In the present embodiment, an example is shown in which the image forming apparatus 107 is connected to the information processing apparatus 101 with a USB cable, and the image forming apparatus 108 is connected thereto through a LAN. It should be noted that there is no restriction on the number of image forming apparatuses connected to the information processing apparatus 101 and a connection standard thereof.

The information processing apparatus 101 is configured to be a personal computer or the like. In the information processing apparatus 101, an application 102 is software used by a user in accordance with a purpose. For example, the user can give an instruction to start printing with the application 102. A V4 driver 103 is a version 4 printer driver which runs on an OS of Windows (registered trademark). The V4 driver 103 is software which receives a print instruction command from the application 102, and generates a print job in accordance therewith.

A standard spooler 104 is a printing spooler of Windows standard included in the OS (in the present embodiment, Microsoft Windows) installed in the information processing apparatus 101. The standard spooler 104 temporarily stores received print jobs, and outputs them one by one in the order of reception. The standard spooler 104 transmits print jobs to a virtual device service 106 through a network. In the present embodiment, the standard spooler 104 transmits print jobs by communication using loop back with which data is transmitted to its source, i.e. the standard spooler 104. In this print system, the standard spooler 104 transmits any jobs to the virtual device service 106.

A status window 105 is software for displaying statuses of the image forming apparatuses 107 and 108, and performing arbitrary settings therefor. The status window 105 has a remote procedure call (RPC) client function, and communicates with the virtual device service 106 by using the function. The status window 105 commands the virtual device service 106 to acquire state information, and displays a status based on the state information received as a response of the command. The status window 105 has model information. In the present embodiment, the model information is a product name.

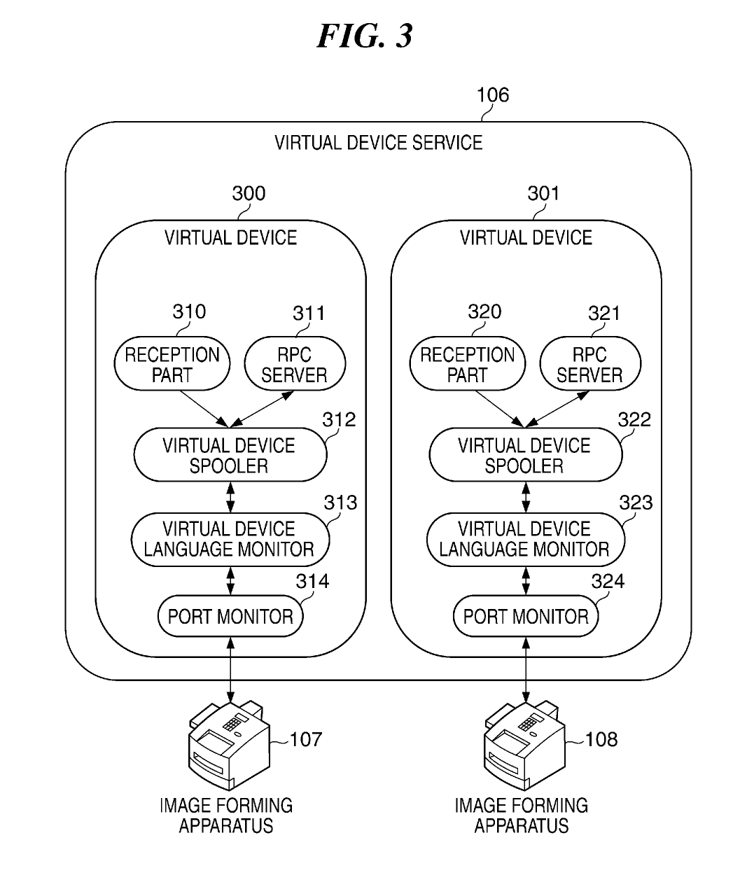

The virtual device service 106 is emulator software which behaves like a physical image forming apparatus to the V4 driver 103, the standard spooler 104, and the status window 105. A network function in Windows is used for communication between the virtual device service 106 and the V4 driver 103, the standard spooler 104, and the status window 105. The image forming apparatuses 107 and 108 are apparatuses having a print function such as a printer, and form an image based on a received print job. The image forming apparatuses 107 and 108 each have model information, and the model information is a product name. In addition, the virtual device service 106 has software (not shown) which is a setting application with which settings and management of virtual devices 300 and 301 (see FIG. 3) are performed. However, a detailed description thereof will be omitted.

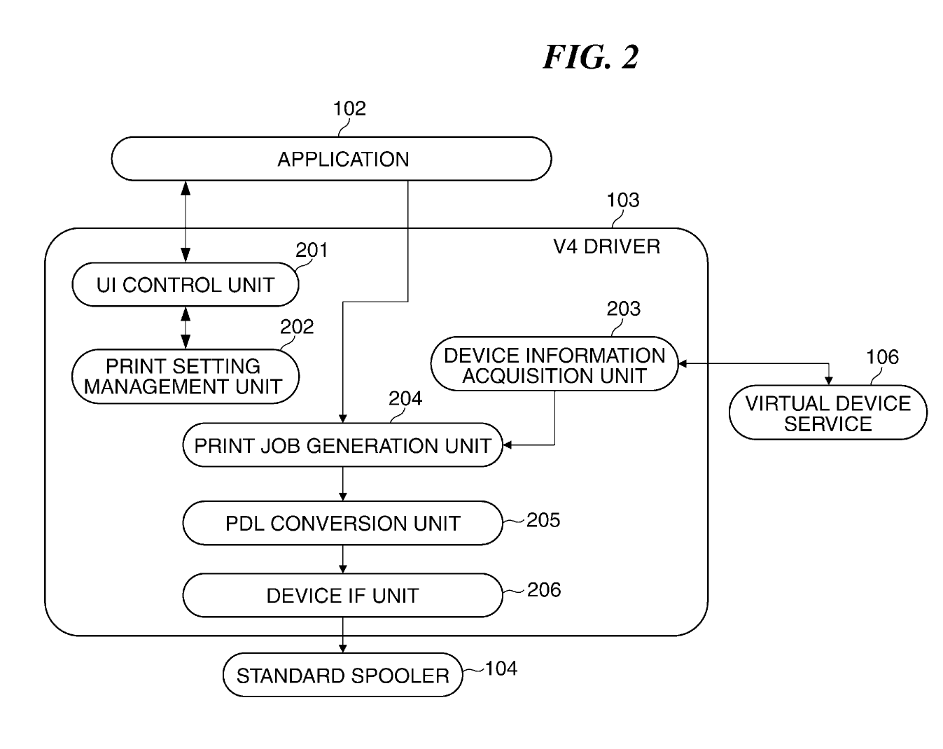

FIG. 2 is a diagram showing a software configuration of the V4 driver 103.

Here, in a case of a conventional V3 driver, an OS (including a driver) is called from the application 102 through an application interface (API) called Win32. Then, binary data called Devmode is used as data for print setting. In a case where Win32 is used as an API, the application 102 calls Graphic Device Interface (GDI) to perform rendering.

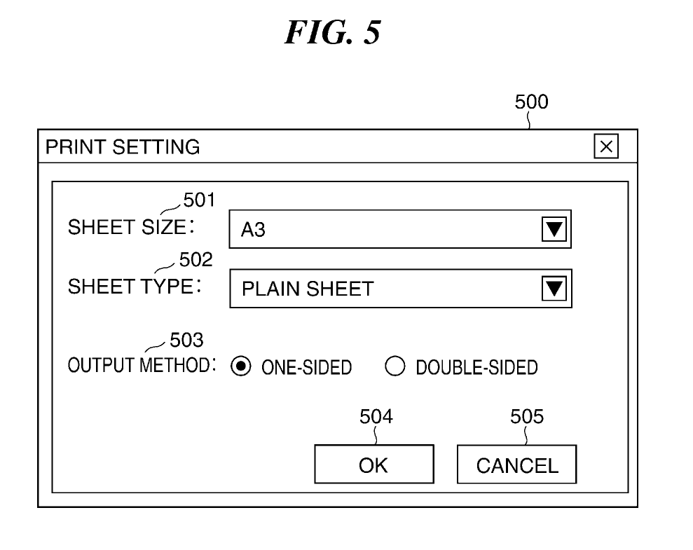

On the other hand, in order to use, with the V4 driver 103, a user interface (UI) equivalent to that for a V3 driver, it is necessary to install software called PrinterExtension. As shown in FIG. 2, the V4 driver 103 includes a UI control unit 201. When a user performs printing with the application 102, the UI control unit 201 displays a UI of PrinterExtension if PrinterExtension has been installed, and if not, the UI control unit 201 displays an OS standard UI. In the present embodiment, the UI control unit 201 displays a UI including such three print setting items of “sheet size,” “sheet type,” and “output method” as shown in FIG. 5. Details of FIG. 5 will be described later.

A print setting management unit 202 manages print setting items displayed with PrinterExtension or the OS standard UI, a default value and an input value for each of the items. The print setting management unit 202 manages a combination of values (contents) of print setting items which cannot be set simultaneously (causes a conflict), and also manages a countermeasure against a conflict to be taken upon occurrence thereof (described later referring to FIG. 10). The print setting items to be displayed and combinations which cause a conflict can be changed for each image forming apparatus (for each model) in accordance with functions and abilities supported by the image forming apparatuses 107 and 108.

In the V4 driver, a print setting is managed by a new print setting format based on eXtensible Markup Language (XML), which is called PrintTicket. XML has replaced a print setting based on Devmode structure in the V3 driver. A device information acquisition unit 203 acquires information (specification information) of an image forming apparatus necessary for generating a print job in a print job generation unit 204. The device information acquisition unit 203 acquires information of the image forming apparatuses 107 and 108 through the virtual device service 106. The device information acquisition unit 203 has the RPC client function, and acquires information of each of the image forming apparatuses 107 and 108 by communicating with RPC servers 311 and 321 (see FIG. 3) included in the virtual device service 106.

The print job generation unit 204 performs rendering or the like in accordance with information of an image forming apparatus acquired from the device information acquisition unit 203, a print setting sent from the application 102, values of print setting items managed by the print setting management unit 202, and generates a print job. The print job generation unit 204 embeds, in the print job, various kinds of information regarding the print job including the values of the print setting items used when generating the print job. Data received by the print job generation unit 204 is XML sheet Specification (XPS) data. When the application 102 which uses Win32 as an API calls GDI, the called GDI is automatically converted to XPS in the OS, and an XPS driver (in the present embodiment, a V4 driver 103) is called. When printing is performed from a Windows Presentation Foundation (WPF) application, the XPS driver (V4 driver) is called as it is. A PDL conversion unit 205 converts the print job to a page description language (PDL) complying with the image forming apparatuses 107 and 108 to which the print job is transmitted. A device IF unit 206 transmits the print job to the standard spooler 104.

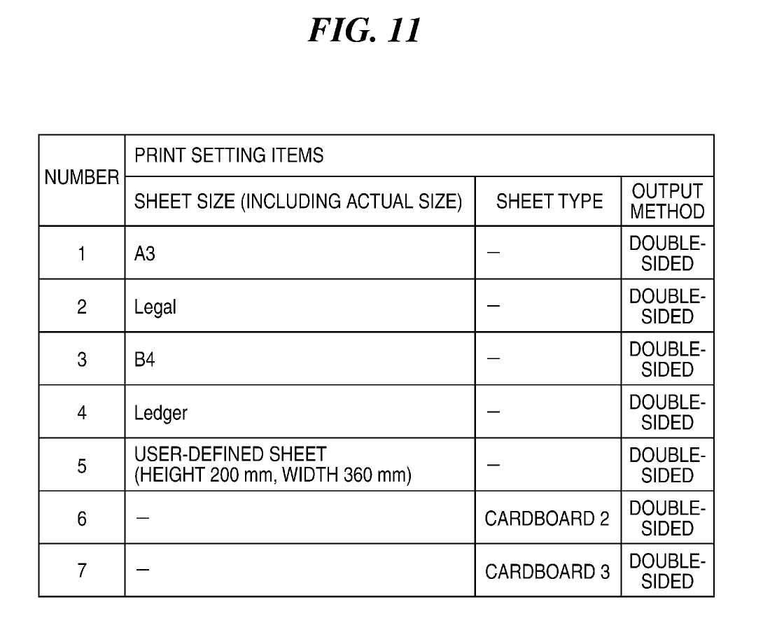

With FIGS. 10 and 11, conflict information for managing combinations of contents of print setting items that cause a conflict will be described. FIG. 10 is a diagram showing an example of conflict information which can be incorporated in the V4 driver 103. In the print setting management unit 202, combinations of contents of three print setting items, i.e. sheet size, sheet type, and output method, which cause a conflict, and a countermeasure against the conflict are managed. In the V4 driver 103, there is the following limitation put by the OS. That is, regarding sheet for which a user can define any size, such as user-defined sheet, the print setting management unit 202 cannot manage a conflict based on a value input by the user. For example, in conflict information shown in FIG. 10, a conflict, which is caused when user-defined sheet is input as the sheet size, is not set. Therefore, when user-defined sheet is input to the sheet size, it is not determined that a conflict is caused irrespective of the actual size of the user-defined sheet.

FIG. 11 is a diagram showing an example of conflict information incorporated in the virtual device service 106 since the conflict information cannot be incorporated in the V4 driver 103. The conflict information shown in FIG. 11 is managed by virtual device language monitors 313 and 323 (FIG. 3) of the virtual device service 106. By this conflict information, combinations of contents of three print setting items, i.e. sheet size (including an actual size), sheet type, and output method, which cause a conflict, and a countermeasure against the conflict are managed. Here, the countermeasure against the conflict is transition to an error state without exception. The conflict information in FIG. 11 includes a combination which cannot be managed by the V4 driver 103. Since the sheet size in the conflict information in FIG. 11 includes an actual size, a combination which causes a conflict can be managed also for user-defined sheet for which a user can define any size.

FIG. 3 is a diagram showing a software configuration of the virtual device service 106. The virtual device service 106 has one or more virtual devices, and each virtual device is connected to one image forming apparatus. In the present embodiment, the virtual device service 106 includes the virtual devices 300 and 301 connected to the image forming apparatuses 107 and 108, respectively.

The virtual device service 106 has a function to receive registration/deletion of virtual devices from an outside source. In order for the virtual device service 106 to register a virtual device by an installer (not shown), a receiving port number of the information processing apparatus 101 is required to be designated. The virtual device service 106 manages the designated receiving port number and the virtual device to be registered in association with each other. The virtual device service 106 has a function to execute the registered virtual device. The virtual device is executed when the virtual device service 106 is executed or a new virtual device is registered.

The virtual device 300 will be described as a representative of the virtual devices. The virtual device 300 includes a reception part 310, a RPC server 311, a virtual device spooler 312, a virtual device language monitor 313 (hereinafter may be abbreviated to language monitor 313), and a port monitor 314. The virtual device 300 holds a product name as model information, and the virtual device spooler 312 included in the virtual device 300 has the product name. The reception part 310 transfers, to the virtual device spooler 312, data of a print job received from the standard spooler 104 through a port number associated with the virtual device 300. The RPC server 311 mediates communication between an external module having the RPC client function such as the status window 105 (FIG. 1) or the device information acquisition unit 203 (FIG. 2) and the virtual device spooler 312 by RPC communication.

The virtual device spooler 312 has a queue for storing the data of the print job transferred from the reception part 310, manages and transmits the stored print job to the language monitor 313. The virtual device spooler 312 provides various accessing units used for acquisition of job information regarding the managed print jobs, deletion of the print jobs, and the like. The accessing units are used by the language monitor 313 or a setting application. The virtual device spooler 312 receives various instructions and responds to the instructions through the RPC server 311. The virtual device spooler 312 transmits various instructions to the language monitor 313, and receives responses to the instructions. In the present embodiment, the virtual device spooler 312 has a product name as model information of the virtual device 300 to which the virtual device spooler 312 belongs.

The language monitor 313 is a module which controls print jobs and manages various kinds of information, and transmits the print job received from the virtual device spooler 312 to the image forming apparatus 107 through the port monitor 314. The language monitor 313 transmits various instructions to the image forming apparatus 107 through the port monitor 314, and acquires various kinds of information from the image forming apparatus 107. In the present embodiment, the language monitor 313 acquires printing states, various states and setting information, error information, and the like of the image forming apparatus 107, and acquires a product name when connected to the image forming apparatus 107. The language monitor 313 determines a state based on information the language monitor 313 has itself and information acquired from the image forming apparatus 107. When the state is determined to be an error state, an error process such as stop of a printing process is performed. The language monitor 313 receives various instructions from the virtual device spooler 312 and responds to the instructions. For example, when receiving an instruction to acquire state information from the status window 105 through the virtual device spooler 312, the language monitor 313 makes a response including state information based on determination of the state and model information. The language monitor 313 analyzes data of a print job, thereby acquiring various kinds of information regarding the print job including values of various print setting items.

The language monitor 313 analyzes a print setting included in the print job based on conflict information shown in FIG. 11, and determines whether a conflict is caused. When it is determined based on the analysis result that various print setting items which constitute the print job cause a conflict, the language monitor 313 takes a countermeasure (specifically, an error process) in accordance with the conflict. Such an error process is the only countermeasure against conflicts since the language monitor 313 in a host-based printing system cannot remake images in accordance with the change in the print setting items.

The language monitor 313 has no limitation put by the OS on conflicts. Therefore, as described above, it is possible to manage conflicts for sheet for which a user can define any size, such as user-defined sheet. For example, conflicts can be managed as follows: although a conflict is caused between user-defined sheet not smaller than a predetermined size and double-sided printing, it is possible to perform double-sided printing for user-defined sheet smaller than the predetermined size. As exemplified in FIG. 11, for example, regarding a setting with respect to a sheet size which exceeds values (height is 200 mm and width is 360 mm) input by a user, a conflict is caused when double-sided printing is input.

The port monitor 314 mediates communication between a port of the information processing apparatus 101 connected to the image forming apparatus 107 and the language monitor 313. Depending on the model of the image forming apparatus 107, types of communication which can be performed by the image forming apparatus 107 may vary. With the port monitor 314, a communication process can be performed which is specialized for the image forming apparatus 107 to be connected.

The other virtual device 301 is connected to the image forming apparatus 108 through a port other than that for the virtual device 300 among ports included in the information processing apparatus 101. A software configuration of the virtual device 301 is similar to that of the virtual device 300, and the virtual device 301 has functions similar to those of the virtual device 300. Configurations of a reception part 320, a RPC server 321, a virtual device spooler 322, a virtual device language monitor 323, and a port monitor 324 in the virtual device 301 are similar to those of components denoted by reference numerals 310, 311, 312, 313, and 314 in the virtual device 300, respectively.

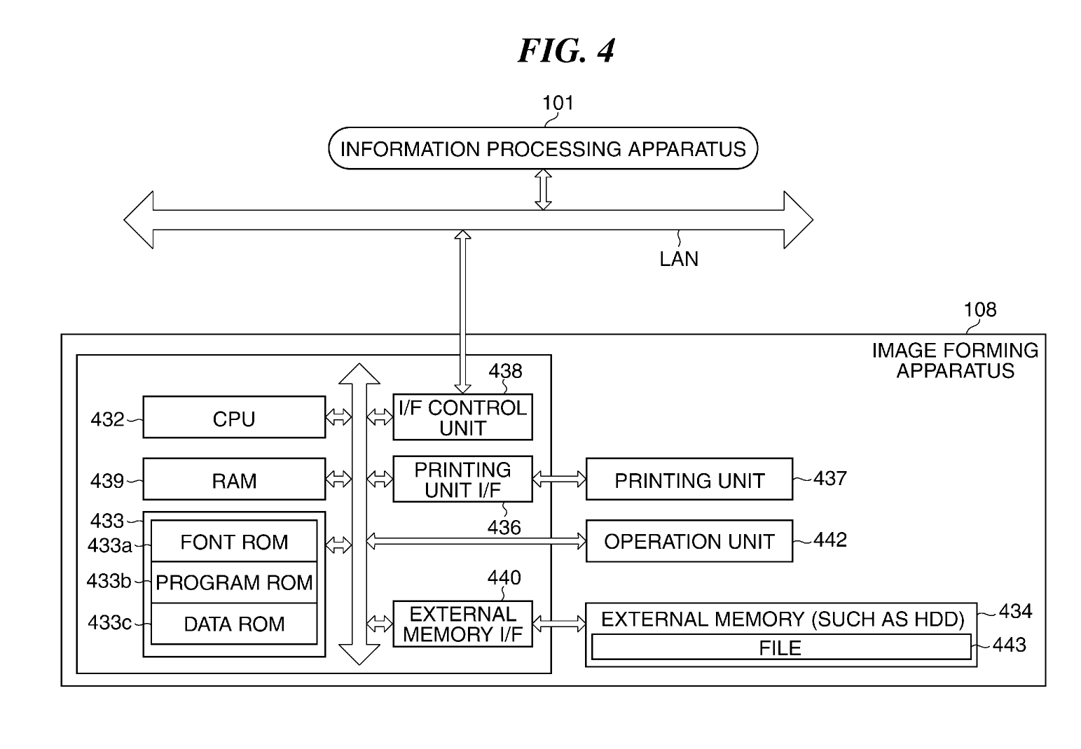

FIG. 4 is a block diagram showing a hardware configuration of the image forming apparatus. In FIG. 4, a configuration of the image forming apparatus 108 will be described as a representative of the image forming apparatus 107 to be USB-connected and the image forming apparatus 108 to be network-connected by a wired LAN.

A CPU 432 controls overall operations of the image forming apparatus 108. A RAM 439 functions as a main memory, a work area, and the like of the CPU 432, and in addition, is used as an output information development area and an environmental data storage area. The RAM 439 also includes an NVRAM (non-volatile RAM) area, and is configured to be able to expand a memory capacity by an optional RAM connected to an expansion socket (not shown). A ROM 433 includes a font ROM 433a, a program ROM 433b, and a data ROM 433c. The font ROM 433a stores various fonts, the program ROM 433b stores a control program and the like executed by the CPU 432, and the data ROM 433c stores various data. An I/F control unit 438 performs transmission and reception of data to and from the information processing apparatus 101, and in the present embodiment, such transmission and reception are performed through a wired LAN.

A printing unit I/F 436 controls an interface with a printing unit 437, which also serves as a printer engine. An external memory 434 includes a hard disk (HD), a solid state disk (SSD), and the like, which are optionally connected, and access thereto is controlled by an external memory I/F 440. The external memory 434 is a hard disk or the like, stores font data, form data and the like, and in addition, can store a file 443, which is a file temporarily generated in the image forming apparatus 108, a file used for transmission and reception to and from external apparatuses, or the like. It should be noted that when the external memory 434 is not connected, information and the like used in the information processing apparatus 101 can be stored in the data ROM 433c in the ROM 433. The number of the external memories 434 is not limited to one, and more than one external memories 434 may be provided. For example, a configuration may be employed in which a plurality of external memories which store an optional font card in addition to a built-in font, a program for interpreting printer control languages of different language systems, and the like, can be connected.

An operation panel which receives an operation by a user is provided to an operation unit 442. A switch for the operation, an LED indicator, and the like are arranged in the operation panel (not shown). It should be noted that the operation unit 442 may include a NVRAM (not shown) such that printer mode setting information from the operation panel can be stored therein. The CPU 432 outputs an image signal as output information to the printing unit 437 through the printing unit I/F 436 via the wired LAN based on a control program or the like stored in the program ROM 433b of the ROM 433. In addition, the CPU 432 can communicate with the information processing apparatus 101 through the I/F control unit 438. A bidirectional communication path is constituted between the I/F control unit 438 and the information processing apparatus 101. With the bidirectional communication path, it is possible to receive a print job transmitted from the information processing apparatus 101, and to notify the information processing apparatus 101 of information and the like included in the image forming apparatus 107.

It should be noted that the image forming apparatus 107 can be realized with a similar configuration to that of the image forming apparatus 108 except that the image forming apparatus 107 is connected to the information processing apparatus 101 via a USB I/F. The present invention can be realized irrespective of types of I/Fs.

FIG. 5 is a view showing an example of a UI displayed by the UI control unit 201. The UI control unit 201 displays a print setting dialog 500. The print setting dialog 500 includes a sheet size setting 501, a sheet type setting 502, an output method setting 503, an OK button 504, and a cancel button 505. The sheet size setting 501 is a drop-down list from which a sheet size can be selected in accordance with functions and abilities supported by the image forming apparatuses 107 and 108. The sheet type setting 502 is a drop-down list from which a sheet type can be selected in accordance with the functions and the abilities supported by the image forming apparatuses 107 and 108. The output method setting 503 is a radio button with which one of multiple output settings can be selected. With the radio button, one-sided or double-sided can be alternatively selected in the present embodiment. By pressing down the OK button 504, the print setting dialog 500 is closed. At that time, the contents input in each of the setting items are determined as contents of the setting, and managed by the print setting management unit 202. By pressing down the cancel button 505, the print setting dialog 500 is closed, and at that time, the content input in each of the setting items is cancelled.

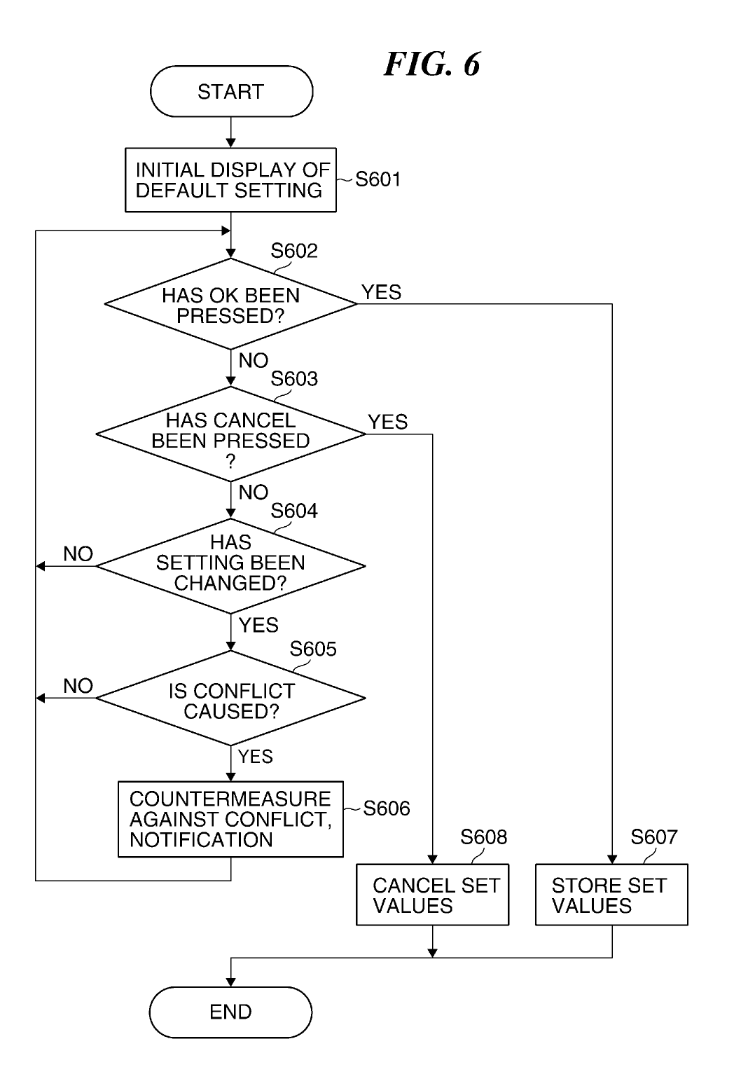

FIG. 6 is a flowchart of a conflict-addressing process performed by the print setting management unit 202. This process is started when a user instructs printing from the application 102. In step S601, the UI control unit 201 displays the print setting dialog 500 (FIG. 5), and the print setting management unit 202 displays a default value held by the print setting management unit 202 as initial display in each of the setting items of the print setting dialog 500 to display. In step S602, the print setting management unit 202 determines whether the OK button 504 has been pressed down by the user. The print setting management unit 202 causes the process to proceed to step S607 in a case where the OK button 504 has been pressed down. On the other hand, in a case where the OK button 504 has not been pressed down, the print setting management unit 202 causes the process to proceed to step S603.

In the step S603, the print setting management unit 202 determines whether the cancel button 505 has been pressed down by the user. Based on the determination result, the print setting management unit 202 causes the process to proceed to step S608 in a case where the cancel button 505 has been pressed down. On the other hand, in a case where the cancel button 505 has not been pressed down, the print setting management unit 202 causes the process to proceed to step S604. In the step S604, the print setting management unit 202 determines whether the user has changed any of values of print setting items (settings 501, 502, and 503). Based on the determination result, the print setting management unit 202 causes the process to return to the step S602 in a case where no print setting item has been changed. On the other hand, in a case where any of the print setting items has been changed, the print setting management unit 202 causes the process to proceed to step S605.

In the step S605, the print setting management unit 202 checks the value of the print setting item changed by the user with the conflict information (FIG. 10), thereby determining whether a conflict has been caused. Based on the determination result, the print setting management unit 202 causes the process to return to the step S602 in a case where the conflict has not been caused. On the other hand, in a case where the conflict has been caused, the print setting management unit 202 causes the process to proceed to step S606. Specifically, the conflict information managed by the print setting management unit 202 is shown by FIG. 10. It is assumed that in the print setting dialog 500 of which a display state is shown in FIG. 5, the output method setting 503 is changed from “one-sided” to “double-sided” when the sheet size setting 501 is “A3.” Then the print setting management unit 202 determines that a conflict defined by the number 1 in FIG. 10 has been caused.

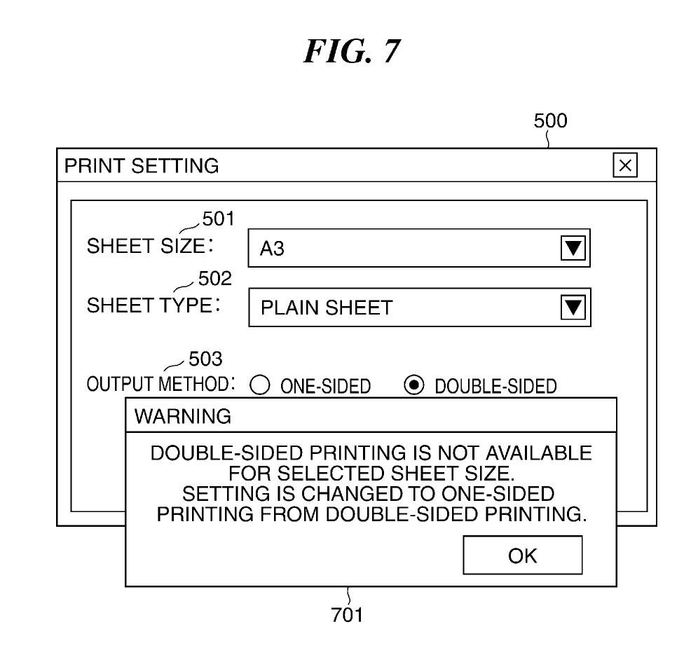

In the step S606, the print setting management unit 202 takes a countermeasure to address the conflict which has been caused, notifies the user of the occurrence of the conflict, and then causes the process to return to the step S602. Specifically, when the conflict defined by the number 1 in FIG. 10 has been caused, the print setting management unit 202 makes a correction of the output method setting into “one-sided” as a countermeasure against the conflict. Moreover, the print setting management unit 202 causes such a warning message 701 as that shown in FIG. 7 to be displayed on the print setting dialog 500, thereby notifying the user of the occurrence of the conflict and the content of the countermeasure against the conflict. When the OK button in the warning message 701 shown in FIG. 7 is pressed down, contents of the corrected settings are displayed on the print setting dialog 500. Therefore, when a conflict has been caused, the print setting management unit 202 determines a print setting which does not cause a conflict, and in response to the OK button being pressed down, makes an automatic correction into the print setting which does not cause a conflict.

In the step S608, the print setting management unit 202 cancels the values set in the print setting dialog 500 without storing the values, and ends the process in FIG. 6. In the step S607, the print setting management unit 202 stores and manages the values currently set in the print setting dialog 500 as determined input values, and ends the process in FIG. 6.

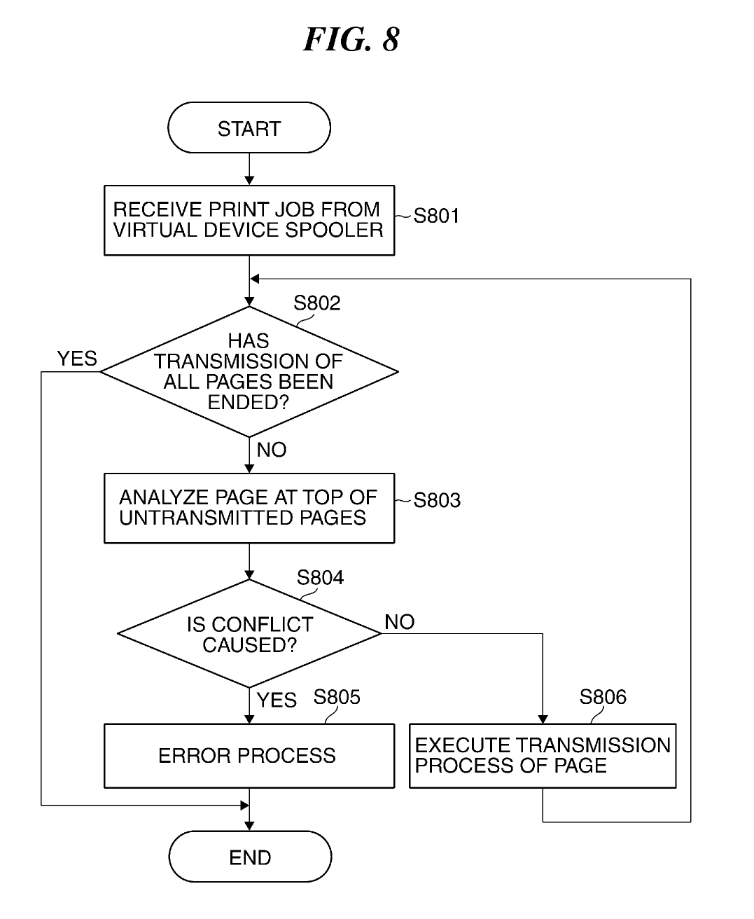

The values of the print setting items stored in the process in FIG. 6 are used thereafter for a process such as rendering performed when the print job generation unit 204 generates a print job. At that time, the print job generation unit 204 embeds, in the generated print job, various kinds of information including print setting items, as a print setting. Thereafter, the generated print job is transmitted to the virtual device 300 (301) included in the virtual device service 106 through the standard spooler 104, and stored in the virtual device spooler 312 (322). When a process of the print job stored in the virtual device spooler 312 (322) is started, a process in FIG. 8, which will be described later, is executed.

FIG. 8 is a flowchart of a conflict-addressing process performed by the virtual device language monitor 313. It should be noted that a conflict-addressing process performed by the virtual device language monitor 323 in the virtual device 301 is similar to the process shown in FIG. 8. Therefore, the process performed by the virtual device 300 will be described as a representative. This process is started when the virtual device 300 receives a print job from the V4 driver 103 through the standard spooler 104.

In step S801, the language monitor 313 receives the print job, which has been received from the V4 driver 103, from the virtual device spooler 312. In step S802, the language monitor 313 determines whether transmission of all pages included in the print job has been completed. The language monitor 313 ends the process in FIG. 8 in a case where the transmission of all pages has been completed. On the other hand, in a case where there is a page left untransmitted, the language monitor 313 causes the process to proceed to step S803. In the step S803, the language monitor 313 analyzes a page at the top of the untransmitted pages in the print job. In other words, the language monitor 313 acquires print setting items included in the print job and analyzes whether a conflict is caused with respect to the page at the top of the untransmitted pages, which is an object to be analyzed, based on various kinds of information including values of the acquired print setting items.

Specifically, it is assumed that conflict information managed by the language monitor 313 is shown in FIG. 11, and regarding the acquired print setting items, user-defined sheet, plain sheet, and double-sided are set as the sheet size setting, the sheet type setting, and the output method setting, respectively. The language monitor 313 refers to the actual size of the user-defined sheet included in the analyzed various kinds of information. In a case where a height thereof exceeds 200 mm, or where a width thereof exceeds 360 mm, the language monitor 313 determines that a conflict defined by the number 5 in FIG. 11 has been caused.

Next, in step S804, the language monitor 313 determines whether a conflict is caused, based on various print setting items constituting the print job, as a result of the analysis performed in the step S803. Based on the determination result, the language monitor 313 causes the process to proceed to step S806 in a case where the conflict is not caused, and executes a transmission process of the page thus analyzed. Consequently, a page which does not cause a conflict in the print job is transmitted. Thereafter, the process is caused to return to the step S802. On the other hand, in a case where the conflict is caused, the language monitor 313 executes an error process in accordance with the conflict in the step S805, in other words, there occurs transition to an error state resulting from the occurrence of the conflict. Consequently, a page which causes a conflict in the print job is not transmitted. Thereafter, the process in FIG. 8 ends.

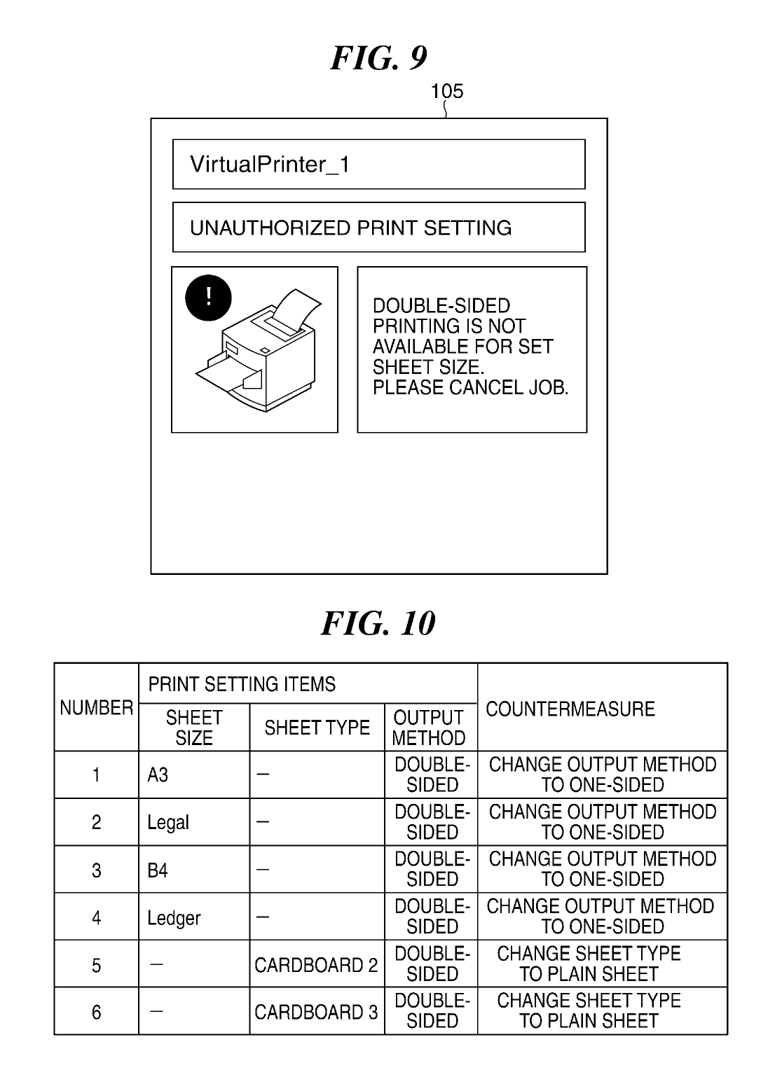

In the error process performed in the step S805, for example, an error screen as shown in FIG. 9 is displayed. In other words, the status window 105 acquires state information from the language monitor 313 which has transitioned to the error state due to the occurrence of the conflict, and displays the error screen to indicate that it is an unauthorized print setting. Consequently, in a case where it is determined by the language monitor 313 that there is a page which causes a conflict in the print job, the occurrence of the error (the occurrence of the conflict) is notified to the image forming apparatus 107.

According to the present embodiment, a print job generated in the V4 driver 103 is transmitted to the virtual device service 106, it is determined in the virtual device service 106 whether a conflict is caused between the print setting items, and a page is transmitted to the image forming apparatus. In the language monitor 313, a combination which cannot be managed by the V4 driver 103 can be managed as conflict information. Therefore, it is possible to prevent a page which causes a conflict from being transmitted based on the analysis result of the print setting included in the received print job. Accordingly, it is possible to prevent a page of a print job including a print setting which cannot be addressed by the image forming apparatus from being transmitted to the image forming apparatus. It is possible to transmit a page which does not cause a conflict with respect to the image forming apparatus.

In the present embodiment, whether a conflict is caused is determined by analyzing a print job for each page included therein. However, whether a conflict is caused or whether transmission can be performed may be determined not in pages but in units other than pages, such as in print jobs. For example, in a case where there is even only one page which causes a conflict in a print job, as a result of the analysis, all pages in the print job may be prevented from being transmitted. Consequently, a print job including a print setting which cannot be addressed by the image forming apparatus (including inconsistent print setting items) is not submitted to the image forming apparatus 107.

It should be noted that in a case where there is a page which causes a conflict, the corresponding print job may be cancelled after an error notice is sent to a user and then a response from the user indicating confirmation of the error is received.

It should be noted that although three items of “sheet size,” “sheet type,” and “output method” are exemplified as the print setting items, there is no limitation to the print setting items. The number and the types of the print setting items to be employed may be different therefrom.

It should be noted that it is sufficient for the virtual device service 106 to be disposed such that the virtual device service 106 can receive a print job generated in the V4 driver 103 and then submit the print job to the image forming apparatus. It is not essential for the virtual device service 106 to be disposed inside the same apparatus which includes the V4 driver 103. Therefore, the virtual device service 106 may be disposed inside a stand-alone apparatus but not limited thereto, and may be disposed in a server or a client, or in any place in a network.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Applications No. 2015-237396, filed Dec. 4, 2015 which is hereby incorporated by reference herein in its entirety.

What is claimed is:

1. A control method for an information processing apparatus, comprising:
a reception step of receiving a print job generated in a printer driver to cause an image forming apparatus to perform printing, from the printer driver;
an analysis step of analyzing a print setting included in the print job received in said reception step based on conflict information for managing a combination that includes a combination of contents of print setting items that causes a conflict and is unmanageable by the printer driver; and
a transmission step of transmitting the print job to the image forming apparatus,
wherein in said transmission step, when the print job is transmitted, at least a page that causes a conflict with respect to the image forming apparatus, in the print job, is not transmitted based on a result of the analysis performed in said analysis step.

2. The control method for an information processing apparatus according to claim 1, wherein in said transmission step, as a result of the analysis performed in said analysis step, a page that does not cause a conflict in the print job is transmitted.

3. The control method for an information processing apparatus according to claim 1, wherein in said transmission step, in a case where there is a page that causes a conflict in the print job, as a result of the analysis performed in said analysis step, all pages in the print job are not transmitted.

4. The control method for an information processing apparatus according to claim 1, further comprising:
a notifying step of notifying the image forming apparatus of occurrence of an error in a case where there is a page that causes a conflict in the print job, as a result of the analysis performed in said analysis step.

5. The control method for an information processing apparatus according to claim 1, wherein the printer driver is a version 4 printer driver that runs on an operating system of Windows (registered trademark).

6. The control method for an information processing apparatus according to claim 1, wherein the print setting items in the conflict information comprise a sheet size that is defined by a user.

7. A control method for an information processing apparatus comprising a printer driver and a virtual device service, and causing an image forming apparatus to print a print job,
wherein the printer driver executes:
a setting step of setting a print setting;
a decision step of deciding a print setting that does not cause a conflict with respect to the image forming apparatus based on first conflict information for managing a combination of contents of print setting items that causes a conflict and the print setting set in said setting step; and
a generation step of generating a print job including information of the print setting decided in said decision step, and
wherein the virtual device service executes:
an analysis step of analyzing a print setting included in the print job generated in said generation step based on second conflict information that manages a combination that includes a combination of contents of print setting items that causes a conflict and is unmanageable by the first conflict information; and
a transmission step of transmitting the print job to the image forming apparatus, wherein in said transmission step, when the print job is transmitted, at least a page that causes a conflict with respect to the image forming apparatus, in the print job, is not transmitted based on a result of the analysis performed in said analysis step.

8. The control method for an information processing apparatus according to claim 7, wherein in said transmission step, as a result of the analysis performed in said analysis step, a page that does not cause a conflict in the print job is transmitted.

9. The control method for an information processing apparatus according to claim 7, wherein in said transmission step, in a case where there is a page that causes a conflict in the print job, as a result of the analysis performed in said analysis step, all pages in the print job are not transmitted at all.

10. The control method for an information processing apparatus according to claim 7, further comprising:
a notifying step of notifying the image forming apparatus of occurrence of an error in a case where there is a page that causes a conflict in the print job, as a result of the analysis performed in said analysis step.

11. The control method for an information processing apparatus according to claim 7, wherein the printer driver is a version 4 printer driver that runs on an operating system of Windows (registered trademark).

12. The control method for an information processing apparatus according to claim 7, wherein the print setting items in the second conflict information comprise a sheet size that is defined by a user.

13. The control method for an information processing apparatus according to claim 7, wherein in said decision step, in a case where the print setting set in said setting step causes a conflict with respect to the image forming apparatus, the set print setting is corrected to a print setting that does not cause a conflict.

14. A computer-readable non-transitory storage medium storing a program for causing a computer to execute a control method for an information processing apparatus, the control method comprising:
a reception step of receiving a print job generated in a printer driver to cause an image forming apparatus to perform printing, from the printer driver;
an analysis step of analyzing a print setting included in the print job received in the reception step based on conflict information for managing a combination that includes a combination of contents of print setting items that causes a conflict and is unmanageable by the printer driver; and
a transmission step of transmitting the print job to the image forming apparatus, wherein in the transmission step, when the print job is transmitted, at least a page that causes a conflict with respect to the image forming apparatus, in the print job, is not transmitted based on a result of the analysis performed in the analysis step.

15. A computer-readable non-transitory storage medium storing a program for causing a computer to execute a control method for an information processing apparatus comprising a printer driver and a virtual device service, and causing an image forming apparatus to print a print job,
wherein in the control method, the printer driver executes:
a setting step of setting a print setting;
a decision step of deciding a print setting that does not cause a conflict with respect to an image forming apparatus based on first conflict information for managing a combination of contents of print setting items that causes a conflict and the print setting set in the setting step; and
a generation step of generating a print job including information of the print setting decided in the decision step, and
wherein the virtual device service executes:
an analysis step of analyzing a print setting included in the print job generated in said generation step based on second conflict information that manages a combination that includes a combination of contents of print setting items that causes a conflict and is unmanageable by the first conflict information; and
a transmission step of transmitting the print job to the image forming apparatus, wherein in the transmission step, when the print job is transmitted, at least a page that causes a conflict with respect to the image forming apparatus, in the print job, is not transmitted based on a result of the analysis performed in the analysis step.

16. An information processing apparatus, comprising:
a reception unit configured to receive a print job generated in a printer driver to cause an image forming apparatus to perform printing, from the printer driver;
an analysis unit configured to analyze a print setting included in the print job received by said reception unit based on conflict information for managing a combination that includes a combination of contents of print setting items that causes a conflict and is unmanageable by the printer driver; and
a transmission unit configured to transmit the print job to the image forming apparatus,
wherein when the print job is transmitted, said transmission unit does not transmit at least a page that causes a conflict with respect to the image forming apparatus, in the print job, based on a result of the analysis performed by said analysis unit.

17. An information processing apparatus comprising a printer driver and a virtual device service, and causing an image forming apparatus to print a print job,
wherein the printer driver comprises:
a setting unit configured to set a print setting;
a decision unit configured to decide a print setting that does not cause a conflict with respect to the image forming apparatus based on first conflict information for managing a combination of contents of print setting items that causes a conflict and the print setting set by the setting unit; and
a generation unit configured to generate a print job including information of the print setting decided by the decision unit, and
wherein the virtual device service comprises:
an analysis unit configured to analyze a print setting included in the print job generated by the generation unit based on second conflict information that manages a combination that includes a combination of contents of print setting items that causes a conflict and is unmanageable by the first conflict information; and
a transmission unit configured to transmit the print job to the image forming apparatus, wherein when the print job is transmitted, the transmission unit does not transmit at least a page that causes a conflict with respect to the image forming apparatus, in the print job, based on a result of the analysis performed by the analysis unit.
